(19) United States
(12) Patent Application Publication
(10) Pub. No.: US 2026/0281523 A1
(43) Pub. Date: Sep. 17, 2026

(54) Conformable sensor-operation, data acquisition, and data processing real-time system

(71) Applicant: Justin Schoenwald, Trumansburg, NY (US)

(72) Inventor: Justin Schoenwald, Trumansburg, NY (US)

(21) Appl. No.: 19/262,141

(22) Filed: Jul. 8, 2025

Related U.S. Application Data
(60) Provisional application No. 63/668,885, filed on Jul. 9, 2024.

(51) Int. Cl. H04N 23/13; H04N 23/52

(52) U.S. Cl. CPC H04N 23/13; H04N 23/52

(57) ABSTRACT

The design of a scientific camera is commonly driven by the particulars of its detector array. Because various detector technologies have specific data processing needs, and various instantiations of a given detector technology have unique electrical and operating characteristics, camera design is generally unique to the detector. The present conception eliminates the need for such case-by-case camera design and manufacture by maximally reducing the number and complexity of hardware components that need to be modified to achieve detector integration. The present conception requires modification of just a single printed circuit board, namely the detector fan-out board, while providing programmable systems for the operation, data acquisition, data processing, analysis, and/or storage for any of a wide range of modern and future detector arrays.

### FIELD OF INVENTION

This invention relates to digital camera design and manufacture.

### BACKGROUND

Digital cameras commonly include an image sensor array combined with electronic circuitry and other hardware dedicated to the operation and utilization of that particular sensor array. Advances in detector technology result in new detector arrays with unique electrical characteristics, operational requirements, and form factors.

In order to characterize a new array's performance, new supporting hardware design is needed to operate the detector, acquire data from it, and either analyze the data or transfer it to another system for analysis.

In order to put a new detector to use in fields such as fluorescent microscopy, quantum imaging, and astronomical imaging and spectroscopy, high-speed acquisition and sophisticated real-time processing capabilities are commonly required.

The development of such supporting hardware typically takes person-years and can be especially onerous due to the consequent delay in putting the new detector array to use.

### SUMMARY

The current disclosure is of a sensor platform that is complete with data acquisition, processing, and storage capabilities, to which adaptation of various current and future detectors requires minimal time and expense.

### BRIEF DESCRIPTION OF THE DRAWINGS

FIG. 1 illustrates, via cross section, that portion of the sensor platform most directly involved with the integration of new detector. The new detector array (1) is mounted on a newly designed fan-out board, i.e. printed circuit board (PCB) (2). All other hardware is independent of sensor design, including the secondary PCB (3) and the connection (4 and 5) to the PCB (7) containing the field programmable gate array (FPGA). The FPGA (6) is to be programmatically configured for sensor-specific i/o and functionality, utilizing in part programmable power supplies which may be located on the secondary PCB (3), to control or drive the detector and acquire data from it.

FIG. 2 illustrates one possible embodiment of a complete sensor platform using some of the more common processing and communication hardware available. FIG. 2 expands on FIG. 1. A PCIe interface (8) provides for high speed data connectivity to a computer workstation. The FPGA is connected, through its PCB and connector (4(3)) to a system-on-module (SOM) (9). The SOM provides multiple CPUs and one or more GPUs for data processing and offers Ethernet (10) and USB (11) connectivity. The enclosure (13), for example an aluminum box, has a window (12) to allow focused radiation to pass onto the detector.

FIG. 3 indicates a vacuum chamber for the sensor with the addition of a partition (15) through which the board connector (5) passes without breaking the vacuum seal, and a valve (16) providing a vacuum pump connection.

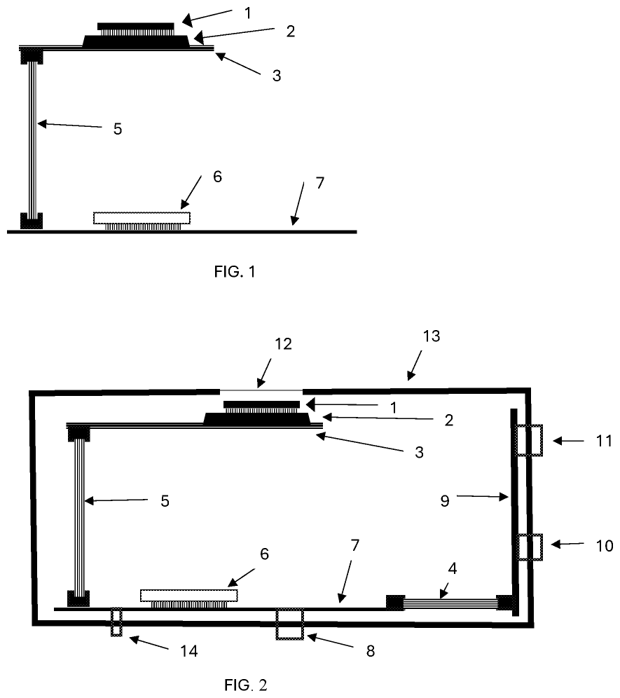

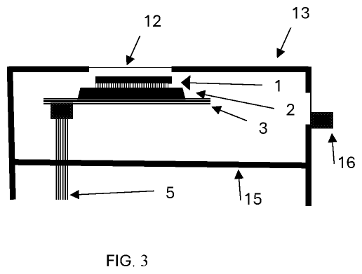

### NOMENCLATURE

Herein, the terms “sensor platform”, “detector platform”, and “camera” are used interchangeably. Although common use of the word “camera” may be more restrictive, herein it refers to the application of detectors of electromagnetic radiation of any frequency range and any intensity, including single photons, and from which the data products are not necessarily two-dimensional images.

The present conception is of a sensor platform that is maximally simple to adapt to electronic sensors of various types, comprising systems to be programmed according to the operational requirements of any particular sensor.

Integration of a new sensor with the platform of [0001] is achieved by designing and implementing a sensor-specific fan-out board (i.e. circuit board) to connect the sensor's digital and analogue contacts to platform circuits which include programmable current sources and a programmable logic device or processor, and by programming the logic device or processor to operate the sensor as required, both electrically and logically.

The platform programmable hardware of [0002], used to directly operate the sensor array, may be a programmable logic device such as a field programmable gate array (FPGA) or a processor unit such as a digital signal processor (DSP).

The sensor platform may incorporate any of the wide variety of data transport and data processing units available, such as a system-on-module (SOM) that includes graphics processing units (GPUs) and central processing units (CPUs), such that acquired data can be manipulated and processed in real time.

The sensor platform may incorporate non-volatile memory for storage of raw and/or processed data.

The sensor platform may incorporate one or more network end points to enable real time remote control and data transfer.

The sensor platform may provide access to the end user for programming any or all platform processors and programmable logic devices, to implement custom data flow, data processing, communications, storage, and/or control of the sensor array.

1. A sensor platform that can incorporate any of a disparate variety of electronic sensors by way of a single circuit board re-design, including programmable hardware that connects to the sensor through said circuit board and which is to be programmed to control the sensor as necessary and acquire digital sensor output.

2. A sensor platform as in claim 1 comprising any number of data processing devices and communication interfaces and composing a real-time data acquisition and processing device that can be programmed and re-programmed to acquire sensor data and process, transfer, and/or store the processed and/or raw sensor data.

3. A sensor platform as in the above claims including a sealed sensor chamber which is optionally to be evacuated and optionally to be cooled via one or more thermoelectric coolers, and/or circulating water, and/or heat pipes, or other means.
